(19) United States
(12) Patent Application Publication
(10) Pub. No.: US 2026/0065886 A1
(43) Pub. Date: Mar. 5, 2026

(54) SINGING DETECTION METHOD AND SINGING DETECTION SYSTEM USING THE SAME

(71) Applicant: Generalplus Technology Inc., Hsinchu City (TW)

(72) Inventors: CHIH HSIANG YANG, Hsinchu City (TW); Li Sheng LO, Hsinchu City (TW)

(21) Appl. No.: 19/311,114

(22) Filed: Aug. 27, 2025

(30) Foreign Application Priority Data
Aug. 30, 2024 (TW) 113132997

(51) Int. Cl. G10H 1/00

(52) U.S. Cl. CPC G10H 1/0066; G10H 2210/066; G10H 2210/071; G10H 2210/076

(57) ABSTRACT

A singing detection method and a singing detection system using the same are provided in the embodiments of the present invention. The singing detection method includes the following steps: performing packet trigger judgment to activate the detection function; conducting rhythm detection on the sound signal; performing pitch detection on the sound signal; quantizing the pitch detection data; converting the quantized data and rhythm detection data into MIDI note data; using the MIDI note data to judge rhythm and pitch changes; assigning weighted scores and comparing with a threshold score. Finally, it determines whether the sound signal is singing based on the total score. This method combines multiple musical feature analyses to identify singing voices through comprehensive scoring.

### CROSS-REFERENCE TO RELATED APPLICATIONS

This application claims priority of No. 113132997 filed in Taiwan R.O.C. on Aug. 30, 2024 under 35 USC 119, the entire content of which is hereby incorporated by reference.

### BACKGROUND OF THE INVENTION

### Field of the Invention

The present invention relates to the application technology for voice recognition, more particularly, the present invention relates to a singing detection method and a singing detection system using the same.

### Description of the Related Art

Singing detection technology plays an important role in the field of music analysis and processing, and its development reflects the progress of audio signal processing and machine learning technologies. Early singing detection primarily relied on basic signal processing techniques, such as spectral analysis and pitch tracking. Although these methods were computationally light, their accuracy and robustness were limited, especially when dealing with complex musical environments.

With the development of machine learning technologies, particularly the rise of deep learning, singing detection has entered a new stage. Researchers began to adopt large neural network models to distinguish between singing and non-singing sounds. These models typically include multi-layer Convolutional Neural Networks (CNN) and Recurrent Neural Networks (RNN), which are capable of automatically learning audio features and achieving high-precision singing detection in various complex musical scenarios.

These deep-learning-based methods have made significant advancements in performance. They are better at handling background music, noise interference, and various singing styles and languages. Some advanced models can even distinguish between choir and solo singing, or recognize specific singers' voices. This high-level singing detection opens up new possibilities for applications such as music information retrieval, automatic lyrics alignment, and singer identification.

However, these high-performance singing detection models also present new challenges. The main issue is their high demand for computational resources and energy. Large neural network models often contain millions or even billions of parameters, requiring powerful processors and large amounts of RAM to operate. This results in a dependency on hardware resources, which limits these models to high-performance servers or desktop computers.

This resource-intensive nature makes previous singing detection technologies unsuitable for low-power MCUs. MCUs typically have limited processing power, smaller amounts of RAM, and strict energy constraints, which prevent them from supporting the operation of large neural network models. This limitation significantly hinders the application of singing detection technology in embedded systems and Internet of Things (IoT) devices.

Implementing singing detection on MCUs faces several challenges. First, the limited computational capacity makes it difficult for complex models to perform inference within a reasonable time. Second, the limited RAM of MCUs makes it infeasible to store the parameters of large models. Finally, the intense computational load leads to a sharp increase in energy consumption, which is unacceptable for MCU devices that are typically battery-powered.

### BRIEF SUMMARY OF THE INVENTION

The objective of a preferred embodiment of the present invention is to provide a singing detection method and a singing detection system using the same, which can operate smoothly in resource-constrained systems without the requirement for high-performance computing, enabling effective singing detection.

In view of this, an exemplary embodiment of the present invention is to provide a singing detection method for determining whether an audio signal is singing. The method includes the following steps: performing a packet trigger judgment on the audio signal to determine whether to activate the singing detection function; conducting a tempo detection on the audio signal to obtain tempo detection data; conducting a pitch detection on the audio signal to obtain pitch detection data; performing a quantization operation on the pitch detection data to obtain quantized data; converting the quantized data and tempo detection data into Musical Instrument Digital Interface (MIDI) note data; and using the MIDI note data to perform rhythm judgment and pitch variation judgment, assigning weights to the scores, and comparing the final accumulated score with a threshold score to determine whether the audio signal is singing.

Another exemplary embodiment of the present invention provides a singing detection system. The singing detection system includes an analog front-end processing circuit, a tempo detection circuit block, a pitch detection circuit block, a quantization calculation circuit block, a data conversion circuit block, and a judgment circuit. The analog front-end processing circuit includes an input and an output, wherein the input of the analog front-end processing circuit receives an audio signal and performs a packet trigger judgment to determine whether to activate the singing detection function. The tempo detection circuit block is coupled to the analog front-end processing circuit. When the singing detection function is activated, it receives a sampled audio signal, performs a tempo detection, and outputs tempo detection data. The pitch detection circuit block is coupled to the analog front-end processing circuit. When the singing detection function is activated, it receives the sampled audio signal, performs a pitch detection, and obtains pitch detection data.

The quantization calculation circuit block receives the pitch detection data and performs a quantization operation to obtain quantized data. The data conversion circuit block receives the quantized data and the tempo detection data, and converts them into Musical Instrument Digital Interface (MIDI) note data. The judgment circuit receives the MIDI note data, performs rhythm judgment and pitch variation judgment, assigns weighted scores to each, and compares the final accumulated score with a threshold score to determine whether the audio signal is singing.

In the singing detection method and the singing detection system using the same according to the preferred embodiment of the present invention, the aforementioned tempo detection circuit block is further used for performing an onset point detection. This onset point detection includes: finding local peak values on the received sampled audio signal along its time axis; and selecting onset point events based on the time and intensity of the local peak values to obtain the tempo detection data.

In the singing detection method and the singing detection system using the same according to the preferred embodiment of the present invention, the operation of the aforementioned pitch detection circuit block further includes: segmenting the received sampled audio signal into multiple audio frames; performing an autocorrelation function calculation on the multiple audio frames based on different delay times to obtain multiple autocorrelation functions, multiple peak values, and the corresponding delay times of the multiple peak values; taking the delay times of the multiple peak values as the fundamental period; and obtaining the fundamental frequency of the audio frame based on the fundamental period.

In the singing detection method and the singing detection system using the same according to the preferred embodiment of the present invention, the plurality of audio frames are represented as s(t), and the autocorrelation function calculation comprises: r(τ)=Σs(t)s(t+τ), where r(τ) represents the autocorrelation function; where t represents the delay time; where, by varying the delay time τ, the peak values of the autocorrelation function r(τ) are identified; and where the adjacent peak values are used as the fundamental period T to obtain the fundamental frequency f=1/T of the calculated audio frame s(t).

In the singing detection method and the singing detection system using the same according to the preferred embodiment of the present invention, the aforementioned analog front-end processing circuit further includes a sampling circuit, a low-pass filter, a framewise energy conversion circuit, and a voice activity detection (VAD) circuit. The sampling circuit receives the audio signal and outputs the sampled audio signal. The low-pass filter performs a low-pass filtering on the sampled audio signal to obtain a low-pass filtered audio signal. The framewise energy conversion circuit receives the low-pass filtered audio signal and performs framewise energy conversion. The voice activity detection circuit is coupled to the framewise energy conversion circuit and outputs a binary result based on the framewise energy conversion, to determine whether the singing detection function should be activated.

In the singing detection method and the singing detection system using the same according to the preferred embodiment of the present invention, the aforementioned judgment circuit uses the MIDI note data to perform rhythm judgment, including: performing a rhythm validity judgment to obtain a rhythm validity score; and performing a rhythm continuity judgment to score the rhythm continuity of the MIDI note data and obtain a rhythm continuity score.

In the singing detection method and the singing detection system using the same according to the preferred embodiment of the present invention, the rhythm validity judgment to obtain the rhythm validity score includes: calculating the beats per minute (BPM) from the MIDI note data; when the BPM is lower than a low beat threshold or higher than a high beat threshold, setting the rhythm validity score to a first score; and when the BPM is higher than the low beat threshold and lower than the high beat threshold, setting the rhythm validity score to a second score.

In the singing detection method and the singing detection system using the same according to the preferred embodiment of the present invention, the rhythm continuity judgment to score the rhythm continuity of the MIDI note data includes: performing an autocorrelation calculation on the MIDI note data; and using the result of the autocorrelation calculation as the rhythm continuity score.

In the singing detection method and the singing detection system using the same according to the preferred embodiment of the present invention, the judgment circuit uses the MIDI note data to perform pitch variation judgment, including: performing a pitch variation judgment to compare the MIDI note data with scale changes and obtaining a pitch variation score; and performing a sustain judgment to score the sustain length of the MIDI note data and obtain a sustain score.

In the singing detection method and the singing detection system using the same according to the preferred embodiment of the present invention, the pitch variation judgment comparing the MIDI note data with scale changes to obtain the pitch variation score includes: identifying the highest and lowest notes in the MIDI note data; and obtaining the pitch variation score based on the difference between the highest and lowest notes in the MIDI note data.

In the singing detection method and the singing detection system using the same according to the preferred embodiment of the present invention, the sustain judgment to score the sustain length of the MIDI note data includes: identifying the longest and shortest note durations in the MIDI note data; and obtaining the sustain score based on the longest and shortest note durations in the MIDI note data.

In the singing detection method and the singing detection system using the same according to the preferred embodiment of the present invention, the judgment circuit uses the MIDI note data to perform both rhythm judgment and pitch variation judgment, each with weighted scoring, and compares the final total score with a threshold score to determine whether the audio signal is a singing signal. It further includes: performing a chord analysis by comparing the MIDI note data with chord data in a database to obtain a chord analysis score; and using the rhythm judgment score, pitch variation judgment score, and chord analysis score, each weighted, and comparing the final total score with a threshold score to determine whether the audio signal is a singing signal.

The essence of the invention is to provides a low-complexity yet high-performance singing detection method, particularly suitable for battery-powered devices, such as toys and other resource-constrained systems. This method cleverly combines key steps such as packet detection, rhythm detection, pitch detection, and quantization to transform complex audio signals into concise musical digital interface note data. By performing weighted analysis of rhythm and pitch variations in these MIDI note data, a reliable judgment result is obtained. This method does not require high-performance processors or large amounts of memory, yet can effectively distinguish between singing and non-singing sounds, significantly expanding the application of singing detection technology in low-power, miniaturized devices. The invention not only enhances the intelligence of resource-constrained devices but also opens up new possibilities for applications in areas such as interactive musical toys and educational tools.

The above-mentioned and other objects, features and advantages of the present invention will become more apparent from the following detailed descriptions of preferred embodiments thereof taken in conjunction with the accompanying drawings.

### BRIEF DESCRIPTION OF THE SEVERAL VIEWS OF THE DRAWINGS

The accompanying drawings are provided to assist those skilled in the relevant technical field in further understanding the present invention, and are incorporated as part of the specification of the invention. The drawings illustrate exemplary embodiments of the present invention and are used together with the description to explain the principles of the invention.

FIG. 1 illustrates a system block diagram of the singing detection system according to a preferred embodiment of the present invention.

FIG. 2 illustrates a circuit block diagram of the analog front-end processing circuit 101 of the singing detection system according to a preferred embodiment of the present invention.

FIG. 3 illustrates a circuit operation waveform diagram of the analog front-end processing circuit 101 of the singing detection system according to a preferred embodiment of the present invention.

FIG. 4 illustrates a circuit operation waveform diagram of the tempo detection circuit block 102 of the singing detection system according to a preferred embodiment of the present invention.

FIG. 5 illustrates a circuit operation waveform diagram of the tempo detection circuit block 102 of the singing detection system according to a preferred embodiment of the present invention.

FIG. 6 illustrates a circuit operation waveform diagram of the pitch detection circuit block 103 of the singing detection system according to a preferred embodiment of the present invention.

FIG. 7A illustrates the waveform and spectrum of singing according to a preferred embodiment of the present invention.

FIG. 7B illustrates the waveform and spectrum of speech according to a preferred embodiment of the present invention.

FIG. 8 illustrates a flowchart of the singing detection method according to a preferred embodiment of the present invention.

FIG. 9 illustrates a flowchart of the sub-steps of step S808 in the singing detection method according to a preferred embodiment of the present invention.

### DETAILED DESCRIPTION OF THE INVENTION

In the detailed description of the exemplary embodiments of the present invention, the exemplary embodiments will be illustrated in the accompanying drawings. Where possible, the same reference numerals are used in the drawings and the description to refer to the same or similar components. Furthermore, the methods of the exemplary embodiments are merely one implementation of the design concept of the present invention, and the following examples are not intended to limit the scope of the invention.

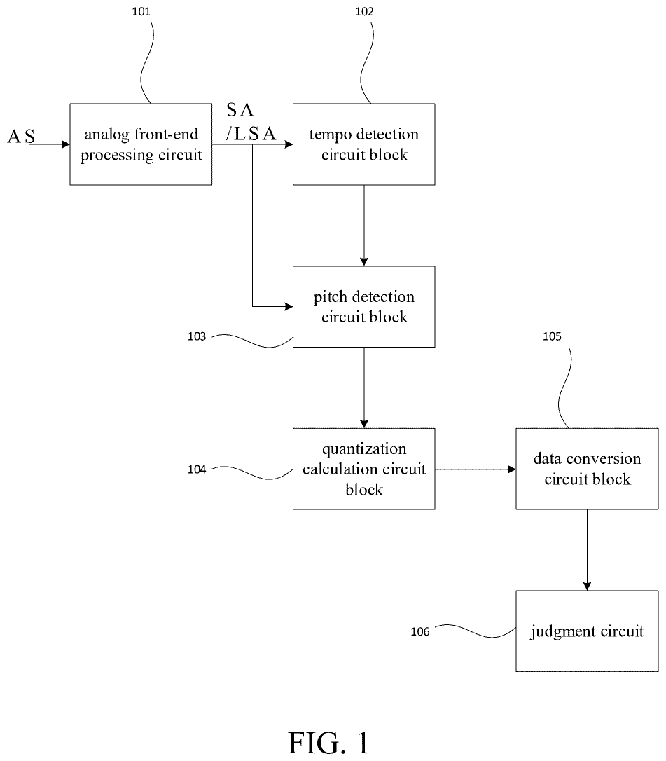

FIG. 1 illustrates a system block diagram of the singing detection system according to a preferred embodiment of the present invention. Referring to FIG. 1, the singing detection system includes a analog front-end processing circuit 101, a tempo detection circuit block 102, a pitch detection circuit block 103, a quantization calculation circuit block 104, a data conversion circuit block 105 and a judgment circuit 106.

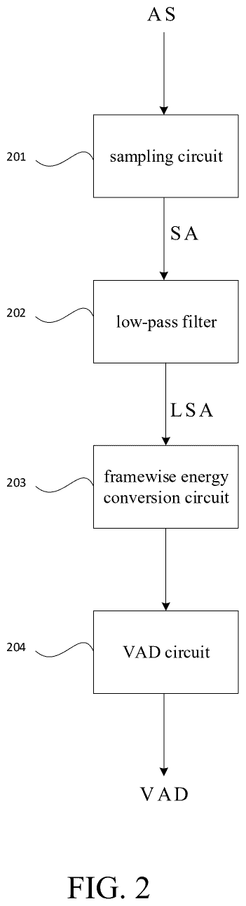

The analog front-end processing circuit 101 in this embodiment is to sample the audio signal as an example. The function of the analog front-end processing circuit 101 is to determine whether the singing detection function is activated or not and to sample the audio signal. Referring to FIG. 2, FIG. 2 illustrates a circuit block diagram of the analog front-end processing circuit 101 of the singing detection system according to a preferred embodiment of the present invention. The analog front-end processing circuit 101 includes a sampling circuit 201, a low-pass filter 202, a framewise energy conversion circuit 203 and a Voice Activity Detection (VAD) circuit 204. The sampling circuit 201 receives and samples the audio signal AS to output the sampled audio signal. The low-pass filter 202 is for applying a low-pass filtering to the sampled audio signal to obtain a low-pass filtered audio signal LSA. The framewise energy conversion circuit 203 receives the low-pass filtered audio signal LSA to perform a framewise energy conversion. The VAD circuit 204 is coupled to the framewise energy conversion circuit 203, performing binary output based on the framewise energy conversion result such that the activation of the singing detection function is determined by the binary output.

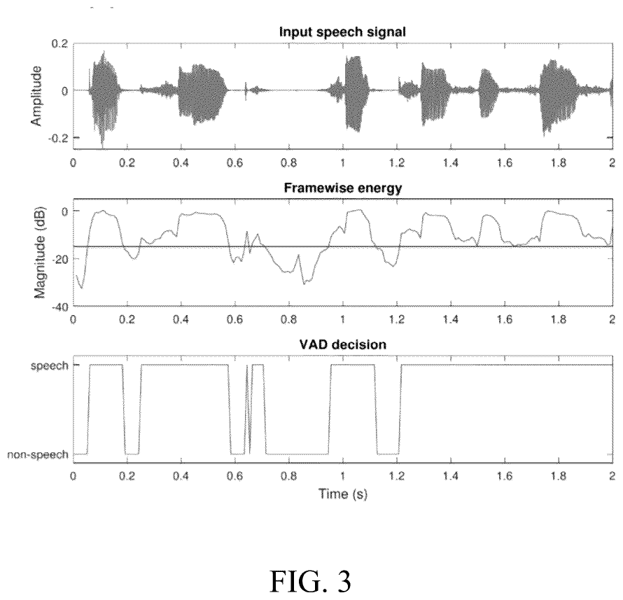

FIG. 3 illustrates a circuit operation waveform diagram of the analog front-end processing circuit 101 of the singing detection system according to a preferred embodiment of the present invention. Referring to FIG. 3, in this embodiment, the audio signal AS is processed by a framewise energy conversion circuit 203 for framewise energy conversion, and then passed through a VAD circuit 204 to generate a binary output (VAD decision). Based on this binary output, it is determined whether to activate the singing detection function.

The tempo detection circuit block 102 is coupled to the analog front-end processing circuit 101. When the analog front-end processing circuit 101 activates the singing detection function, the tempo detection circuit block 102 receives, for example, the sampled audio signal SA or the low-pass filtered audio signal LSA, and performs a tempo detection on the sampled audio signal SA or the low-pass filtered audio signal LSA, outputting tempo detection data.

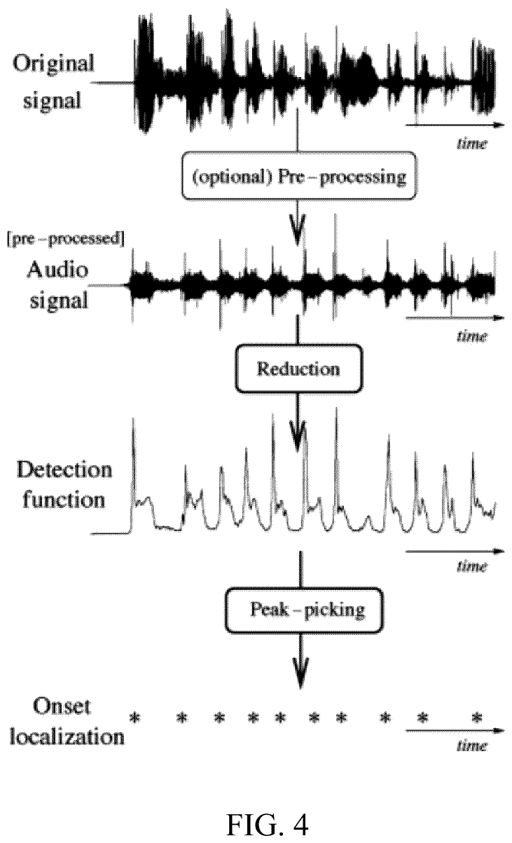

FIG. 4 illustrates a circuit operation waveform diagram of the tempo detection circuit block 102 of the singing detection system according to a preferred embodiment of the present invention. Referring to FIG. 4, the operation of the tempo detection circuit block 102 first receives the input original signal, which is the initial sampled audio signal SA. After that, an optional pre-processing is performed on the original signal for preliminary processing, such as filtering, normalization, and other operations. Next, the signal is simplified (Reduction), where the pre-processed signal is transformed into a simpler form, such as envelope detection. A common implementation of envelope detection involves taking the absolute value of the signal and using a low-pass filter to smooth the result. This method effectively highlights the overall energy variation of the signal, thereby emphasizing the tempo characteristics. After the signal is simplified, a detection function calculation is performed, converting the simplified signal into a detection function, the peaks of which correspond to the tempo points in the original signal. Finally, peak-picking is performed, where significant peaks are selected from the detection function, and based on the selected peaks, time, and intensity, the specific time points of the tempo in the original signal are determined.

The abovementioned embodiment describes the operation of the tempo detection circuit block 102 in the aforementioned manner. An alternative method for tempo detection is now presented, which will be explained using the following code:

def MultiplePeakFinding (signal):
peakIndices=[ ]
peakIndex=None
peak Value=None
baseline=sum(signal)/len(signal)
for index, value in enumerate (signal):
   if value>baseline:
      if peak Value is None or value>peak Value:
         peakIndex=index
         peak Value=value
   elif value<baseline and peakIndex is not None:
      peakIndices.append (peakIndex)
      peakIndex=None
      peak Value=None
if peakIndex is not None:
   peakIndices.append (peakIndex)
return peakIndices

In this embodiment, the input audio signal is converted into a spectrum. Initially, the variables peakIndices, peakIndex, and peak Value are initialized. peakIndices is used to store the indices of the found peaks, while peakIndex and peak Value are used to temporarily store the current potential peak being processed. A baseline variable is also defined, which calculates the average value of the signal to serve as the baseline. If the current value is above the baseline, and if it is the first point above the baseline or higher than any previously found peak, peakIndex and peak Value are updated. If the current value is below the baseline and a potential peak has been found previously, the index of the found peak is added to peakIndices, and peakIndex and peak Value are reset in preparation for finding the next peak. Finally, if there are any remaining unprocessed peaks at the end, they are added to peakIndices, and all the found peak indices are returned. This algorithm can identify significant peaks in the spectrum, which may correspond to note onset points in music.

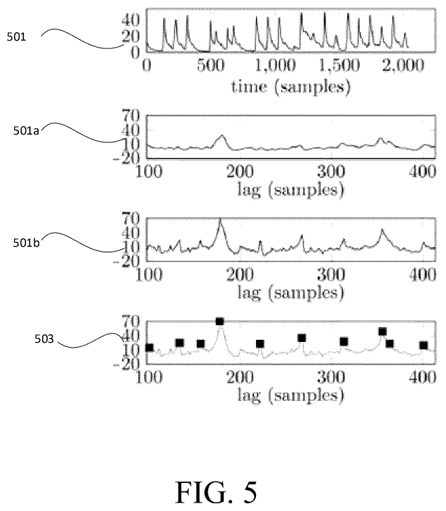

In addition to the two embodiments of the operation of the tempo detection circuit block 102 described above, another method can be used, such as employing the auto-correlation function to search for the periodicity of peak points and identify note onsets. FIG. 5 illustrates a circuit operation waveform diagram of the tempo detection circuit block 102 of the singing detection system according to a preferred embodiment of the present invention. Referring to FIG. 5, label 501 represents the amplitude variation of the original audio signal over time. For example, label 501 shows the onset signal calculated from the original signal, which corresponds to the onset time of a voiced sound or the time when the vocal cords start to vibrate. Label 502a represents the result of the auto-correlation function, while label 502b represents the result after harmonic enhancement of the auto-correlation function. The typical auto-correlation operation is performed by extending the original signal A along the time axis as follows: A(t)+A(2t)+A(4t)+ . . . . Since beats occur periodically, if the time extension is accumulated, the parts of the signal that correspond to beats will be further strengthened. Finally, label 503 represents the selected peaks (black squares), which correspond to the detected note onset points or beat positions. The method illustrated in FIG. 5 is more complex than the peak detection method described earlier and requires more memory to store intermediate calculation results. Therefore, when this embodiment is applied to resource-constrained systems, the first method of searching for tempo is preferred.

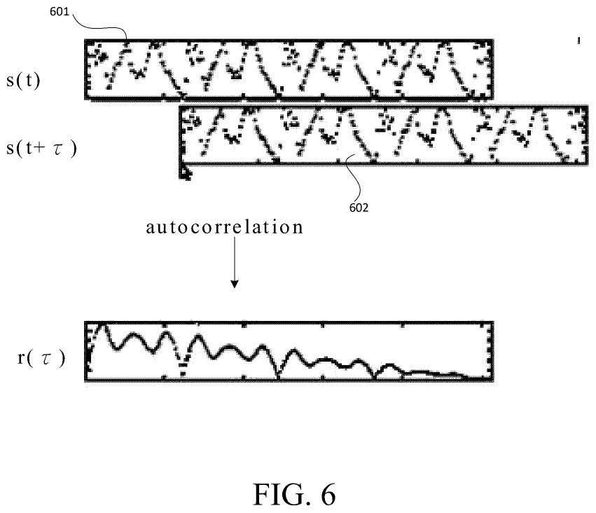

The pitch detection circuit block 103 is also coupled to the analog front-end processing circuit 101. When the analog front-end processing circuit 101 activates the singing detection function, a pitch detection is performed to obtain pitch detection data. The operation of the pitch detection circuit block 103 is shown in FIG. 6. FIG. 6 illustrates a circuit operation waveform diagram of the pitch detection circuit block 103 of the singing detection system according to a preferred embodiment of the present invention. First, the pitch detection circuit block 103 segments the received sampled audio signal SA into multiple audio frames, as indicated by label 601. The mathematical notation for these audio frames is defined as s(t). Next, based on different delay times, the multiple audio frames are delayed, and the delayed audio frame 602 is defined as s(t+τ), where τ is the delay time. Then, an autocorrelation function calculation is performed to obtain multiple autocorrelation functions, as well as multiple peaks and their corresponding delay times. The delay times of these peaks are used as the fundamental period, which is then used to obtain the pitch of the audio frame. An example of the autocorrelation function calculation is:

r(τ)=Σs(t)s(t+τ),

where r(τ) represents the autocorrelation function; where τ represents the delay time; where, by varying the delay time T, the peak values of the autocorrelation function r(τ) are identified; and where the adjacent peak values are used as the fundamental period T to obtain the fundamental frequency f=1/T of the calculated audio frame s(t).

The quantization circuit block 104 receives the pitch detection data and performs a quantization operation to obtain quantized data. The data conversion circuit block 105 receives the quantized data and tempo detection data, and converts them into Musical Instrument Digital Interface (MIDI) note data. Since the complex audio signal is transformed into concise MIDI note data, this reduces the computational load and memory usage in subsequent processing.

The judgment circuit 106 receives the MIDI note data and performs rhythm and pitch variation assessments, assigning weights and scores. The final total score obtained is then compared with a threshold score to determine whether the audio signal corresponds to singing. In this embodiment, the rhythm judgment includes a rhythm validity check and a rhythm continuity check. The rhythm validity check, specifically, is based on the fact that songs are composed of syllables, and the number of beats within a syllable should be fixed, for example, in time signatures like 4/4, 2/4, or ⅜. Each song also has a certain tempo. Typical tempo ranges for various music genres are: Ballad: 50-80 BPM; Slow Rock/Folk: 60-90 BPM; Dance/Hi-hop/Rap: 90-120 BPM; Funk/R&B/Country: 80-120 BPM; Rock: 90-140 BPM; Metal: 140-180 BPM. Therefore, in this embodiment, rhythms with a tempo below 50 BPM or above 180 BPM are excluded. When the MIDI note data is processed through tempo detection, it results in a beats per minute (BPM) value. If the BPM is below 50 or above 180, it can be confirmed that the segment of audio is not singing. Thus, in this embodiment, if the BPM is between 50 and 180, the rhythm validity score is set to 1; if it is outside this range, the rhythm validity score is set to 0. In programmatic terms, the rhythm validity score S1 can be expressed as follows:

### S1=if (BPM>50 & BPM<180) 1;

else 0;

Next, the rhythm of a typical song has a certain duration, which distinguishes it from speech. Speech does not follow a fixed pattern of syllables or beats, and its speed is not regulated. However, singing has a certain rhythm continuity. Therefore, in this embodiment, a rhythm continuity check is also performed. The rhythm continuity check calculates the autocorrelation function of the MIDI note sequence from the above-mentioned MIDI note data.
S2=autocorrelation (midi_notes)
wherein the smaller the rhythm continuity score S2, the less relevant it is.

The judgment circuit 106 also performs a pitch variation assessment to obtain a pitch variation score. Generally speaking, there is a noticeable difference in pitch variation between speaking and singing. The pitch variation in most people's speech is typically around 2.5 semitones. By analyzing the MIDI note data, the highest and lowest pitches can be identified, and by calculating the difference between them, if the difference is greater than 2.5 semitones, it is highly likely that the audio is singing. In other words, by identifying the highest and lowest notes in the MIDI note data and calculating the difference between them, the pitch variation score S3 is obtained. In programmatic terms, the pitch variation score S3 can be expressed as follows:
S3=find_notes_difference (midi_notes)
def find_notes_difference (midi_notes):
   max_note=max (midi_notes)
   min_note=min (midi_notes)
   difference=max_note-min_note
return difference

In the above embodiment, the greater the pitch variation, the higher the likelihood of singing. Therefore, the pitch variation score S3 is also higher.

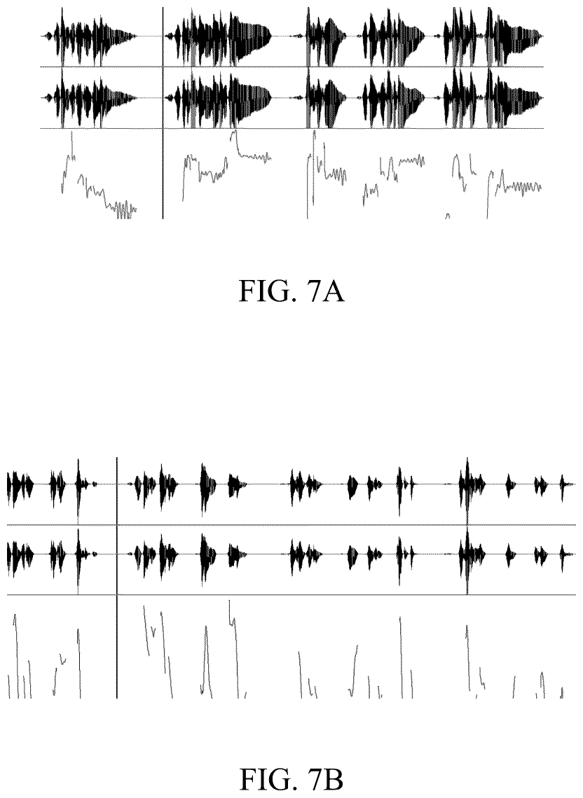

Besides the pitch judgment described above, the judgment circuit 106 can also perform an additional sustain note assessment. Generally, singing involves sustained notes with a single pitch, while speech does not exhibit this characteristic as clearly. FIG. 7A illustrates the waveform and spectrum of singing according to a preferred embodiment of the present invention. FIG. 7B illustrates the waveform and spectrum of speech according to a preferred embodiment of the present invention. Referring to FIG. 7A and FIG. 7B, a comparative analysis of the spectrograms from the two figures reveals that the waveforms are different, and the frequency patterns are significantly distinct. From the frequency analysis, it can be observed that in singing, each note has a specific standard, continuity, and regular variation, whereas in speech, the pitch of each word lacks a standard and does not follow a regular pattern of change.

Therefore, in this embodiment, the longest and shortest sound duration periods are identified from the MIDI note data. In this case, the duration corresponds to the note duration in the MIDI data. Based on the duration, a sustain score is then determined. Since singing involves variations such as whole notes, eighth notes, quarter notes, etc., the time with the maximum difference in sound duration is identified. If the difference in duration is too small, it indicates a higher likelihood of speech. In programmatic terms, the sustain score S4 can be expressed as follows:
def find_duration_difference (durations):
   max_duration=max (durations)
   min_duration=min (durations)
   difference=max_duration-min_duration
   return difference
S4=find_duration_difference (durations)

The judgment circuit 106 synthesizes all the above scores and assigns the following weights:

Score=W1*S1+W2*S2+W3*S3+W4*S4

When the total score exceeds the predefined threshold, it can be considered singing rather than speaking. The designer can adjust the weights W1˜W4 set within the judgment circuit 106 according to the specific requirements, in order to obtain results that are suitable for the current data.

For example, if the weights are set to be equal, W1=W2=W3=W4=1, and the threshold value is set to 10, the MIDI notes for the “Happy Birthday” song are as follows:
midi_notes=[
   60 (1), 60 (1), 62 (2), 60 (2), 65 (2), 64 (4),
   60 (1), 60 (1), 62 (2), 60 (2), 67 (2), 65 (4),
   60 (1), 60 (1), 60 (2), 69 (2), 65 (2), 64 (2), 62 (4),
   70 (1), 70 (1), 69 (2), 65 (2), 67 (2), 65 (4)
]

Here, the numbers in parentheses, such as (1), indicate that the note lasts for 1 beat, and (2) indicates it lasts for 2 beats, and so on. The number before the parentheses indicates the pitch. Therefore, using the above method of score calculation for the MIDI notes of the “Happy Birthday” song, we obtain S1=1; S2=6; S3=10; S4=3. The calculated score is:

Score=(11+16+110+13)=20, which is greater than the threshold (10). The judgment circuit 106 can then determine that the input audio signal is singing rather than speaking.

Additionally, to improve the accuracy of the judgment, the judgment circuit 106 can also perform a chord analysis. It compares the Musical Instrument Digital Interface (MIDI) note data with chord data from a database to obtain a chord analysis score. Generally speaking, 66% of songs use the following three types of chords: I. Canon; II. 1-5-6-4 chord progression; III. 4-5-3-6 chord progression. The converted chords are then compared with the reference chords and scored accordingly. Finally, based on the combined information, weights are assigned. When the total score, calculated as Score=W1*S1+W2*S2+W3*S3+W4*S4+W5*S5, exceeds the predefined threshold, it can be determined that the audio signal is singing rather than speaking.

As can be seen from the above embodiment, because this approach uses multiple judgment criteria for scoring, even if each individual judgment criterion cannot completely distinguish between singing and normal speech, the use of multiple parameters with different weights can mitigate the aforementioned limitations, making the judgment more accurate. Additionally, the embodiment described above converts the original audio into MIDI note data, which significantly reduces the computational load and the complexity of the judgment operations.

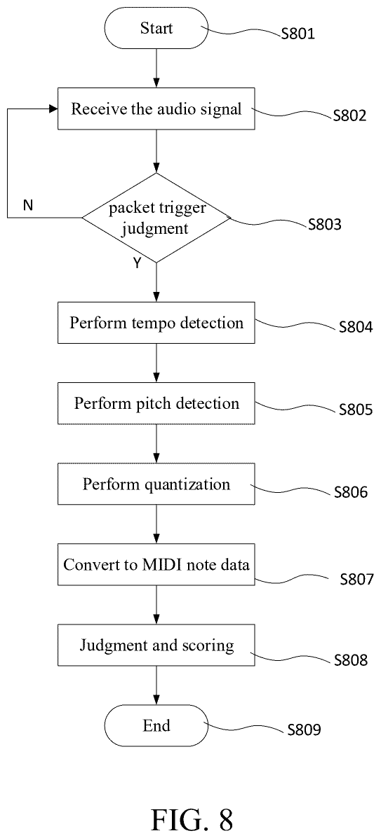

From the above embodiment, a singing detection method can be summarized. FIG. 8 illustrates a flowchart of the singing detection method according to a preferred embodiment of the present invention. Referring to FIG. 8, the singing detection method includes the following steps:

Step S801: Start.

Step S802: Receive the audio signal.

Step S803: Perform a packet trigger judgment. The received audio signal is processed through the packet trigger judgment to convert it into binary data, determining whether to activate the singing detection function. If the judgment is ‘no’, return to Step S802. If the judgment is ‘yes’, proceed to Step S804.

Step S804: Perform tempo detection. As described in the embodiment, the tempo detection is performed on the sampled audio signal to obtain tempo detection data.

Step S805: Perform pitch detection. As described in the embodiment, the pitch detection is performed on the sampled audio signal to obtain pitch detection data.

Step S806: Perform quantization. The pitch detection data is subjected to quantization to obtain quantized data.

Step S807: Convert to MIDI note data. Using the quantized data and the tempo detection data, the data is converted into MIDI note data.

Step S808: Judgment and scoring. Using the MIDI note data, rhythm judgment and pitch variation judgment are performed, with weights assigned for scoring. The final total score is compared with the threshold score to determine whether the audio signal corresponds to singing.

Step S809: End.

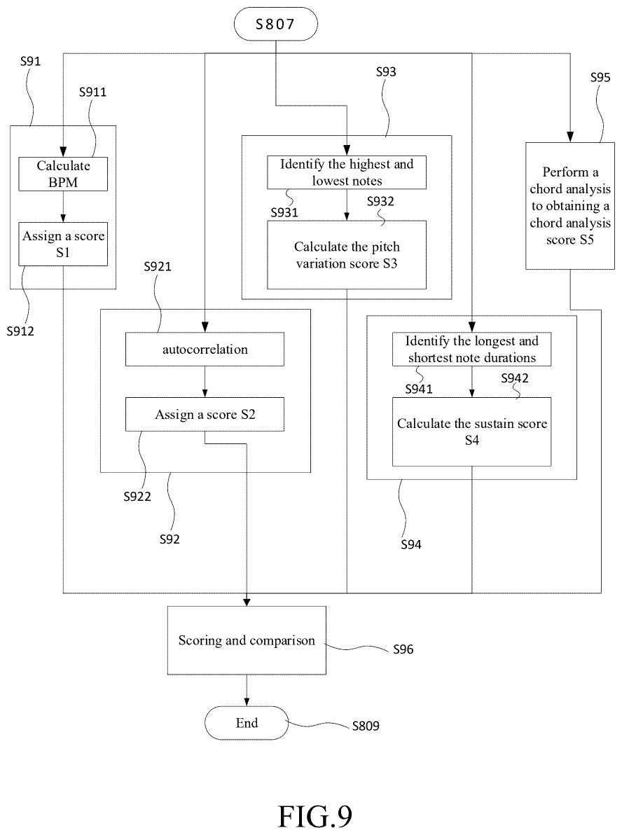

FIG. 9 illustrates a flowchart of the sub-steps of step S808 in the singing detection method according to a preferred embodiment of the present invention. Referring to FIG. 9, the sub-steps of Step S808 in the singing detection method include the following steps:

Step S91: Perform a rhythm validity judgment to obtain a rhythm validity score. Step S91 includes the following steps:

Step S911: Calculate the beats per minute (BPM) of the MIDI note data.

Step S912: Assign a score S1. When the BPM is lower than a low-beat threshold or higher than a high-beat threshold, set the rhythm validity score to a first score, such as 0 points in the above embodiment; when the BPM is higher than the low-beat threshold and lower than the high-beat threshold, set the rhythm validity score to a second score, such as 1 point in the above embodiment.

Step S92: Perform a rhythm continuity judgment to score the rhythm continuity of the MIDI note data, obtaining a rhythm continuity score. Step S92 includes the following steps:

Step S921: Perform an autocorrelation operation on the MIDI note data.

Step S922: Use the result of the autocorrelation operation as the rhythm continuity score S2. Specifically, refer to the above embodiment.

Step S93: Perform a pitch variation judgment to compare the pitch changes in the MIDI note data, obtaining a pitch variation score. Step S93 includes the following steps: Step S931: Identify the highest and lowest notes in the MIDI note data.

Step S932: Calculate the pitch variation score S3 based on the difference between the highest and lowest notes in the MIDI note data.

Step S94: Perform a sustain judgment to score the sustain length of the MIDI note data, obtaining a sustain score. Step S94 includes the following steps:

Step S941: Identify the longest and shortest note durations in the MIDI note data.

Step S942: Calculate the sustain score S4 based on the longest and shortest note durations in the MIDI note data.

Step S95: Perform a chord analysis to compare the MIDI note data with chord data from a database, obtaining a chord analysis score S5. Perform chord analysis and obtain the chord analysis score S5.

Step S96: Scoring and comparison. Multiply the scores S1 to S5 by their respective weights and compare them with the predefined threshold score to determine whether it is singing. The scores S1 to S5 above are for illustrative purposes; any parameter can be changed or removed based on design considerations. For the detailed technical scope, please refer to the patent claims. Additionally, the number of weights will change depending on the parameters, and the design of the weights will vary based on the actual situation and the designer's experiments, which will not be further elaborated here.

In summary, the essence of the invention is to provides a low-complexity yet high-performance singing detection method, particularly suitable for battery-powered devices, such as toys and other resource-constrained systems. This method cleverly combines key steps such as packet detection, rhythm detection, pitch detection, and quantization to transform complex audio signals into concise musical digital interface note data. By performing weighted analysis of rhythm and pitch variations in these MIDI note data, a reliable judgment result is obtained. This method does not require high-performance processors or large amounts of memory, yet can effectively distinguish between singing and non-singing sounds, significantly expanding the application of singing detection technology in low-power, miniaturized devices. The invention not only enhances the intelligence of resource-constrained devices but also opens up new possibilities for applications in areas such as interactive musical toys and educational tools.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A singing detection method for determining whether an audio signal is singing, the method comprising:
performing a packet-trigger judgment on the audio signal to determine whether to activate a singing detection function;
performing a tempo detection on the audio signal to obtain a tempo detection data;
performing a pitch detection on the audio signal to obtain a pitch detection data;
performing a quantization operation on the pitch detection data to obtain a quantized data;
converting the quantized data and the tempo detection data into a Musical Instrument Digital Interface (MIDI) note data; and
performing a rhythm judgment and a pitch variation judgment to the MIDI note data, respectively assigning weights to scores for each, and comparing a final total score with a threshold score to determine whether the audio signal is singing.

2. The singing detection method according to claim 1, wherein, for the audio signal, the tempo detection is performed to obtain the tempo detection data, comprising:
performing a note detection, including:
searching for local peak values on the audio signal along the timeline;
based on the time and intensity of the local peak values, determining and selecting the onset point events to obtain the tempo detection data.

3. The singing detection method according to claim 1, wherein, for the audio signal, the pitch detection is performed to obtain the pitch detection data, comprising:
dividing the audio signal into a plurality of audio frames;
performing an autocorrelation function calculation on the plurality of audio frames with different delay times, to obtain a plurality of autocorrelation functions, along with a plurality of peak values and their corresponding delay times;
using the delay times of the plurality of peaks as the fundamental period T; and
calculating the fundamental frequency of the audio frame as f=1/T.

4. The singing detection method according to claim 3, wherein the plurality of audio frames are represented as s (t), and the autocorrelation function calculation comprises:
r(τ)=Σs(t)s(t+τ)
where r(τ) represents the autocorrelation function;
where τ represents the delay time;
where, by varying the delay time τ, the peak values of the autocorrelation function r(τ) are identified; and
where the adjacent peak values are used as the fundamental period T to obtain the fundamental frequency f=1/T of the calculated audio frame s (t).

5. The singing detection method according to claim 1, wherein performing a packet-trigger judgment on the audio signal to determine whether to activate a singing detection function, comprises:
performing a low-pass filtering on the audio signal to obtain a low-pass filtered audio signal;
performing a framewise energy conversion on the low-pass filtered audio signal; and
performing a Voice Activity Detection (VAD) binary output based on the framewise energy conversion result to determine whether to activate the singing detection function.

6. The singing detection method according to claim 1, wherein, by using the Musical Instrument Digital Interface (MIDI) note data, a rhythm judgment is performed, comprising:
performing a rhythm validity judgment to obtain a rhythm validity score; and
performing a rhythm continuity judgment, where the rhythm continuity of the MIDI note data is evaluated to obtain a rhythm continuity score.

7. The singing detection method according to claim 6, wherein, performing the rhythm validity judgment to obtain the rhythm validity score comprises:
calculating a beats per minute (BPM) for the Musical Instrument Digital Interface (MIDI) note data;
setting the rhythm validity score to a first score when the BPM is below a low beat threshold or above a high beat threshold; and
setting the rhythm validity score to a second score when the BPM is above the low beat threshold and below the high beat threshold.

8. The singing detection method according to claim 6, wherein, performing the rhythm continuity judgment, the rhythm continuity of the MIDI note data is evaluated to obtain the rhythm continuity score, comprising:
performing an autocorrelation operation on the MIDI note data; and
using a result of the autocorrelation operation as the rhythm continuity score.

9. The singing detection method according to claim 1, wherein, by the MIDI note data, a pitch variation judgment is performed, comprising:
performing a pitch variation judgment by comparing the MIDI note data to detect scale variations, and obtaining a pitch variation score; and
performing a sustain judgment by evaluating the sustain duration of the MIDI note data, and obtaining a sustain score.

10. The singing detection method according to claim 9, wherein, performing the pitch variation judgment by comparing the Musical Instrument Digital Interface (MIDI) note data to detect scale variations, and obtaining the pitch variation score, comprising:
identifying a highest and lowest notes in the MIDI note data;
calculating the pitch variation score based on the difference between the highest and lowest notes in the MIDI note data.

11. The singing detection method according to claim 9, wherein, performing the sustain judgment by evaluating the sustain duration of the Musical Instrument Digital Interface (MIDI) note data, and obtaining the sustain score, comprising:
identifying the longest and shortest note durations in the MIDI note data;
calculating the sustain score based on the longest and shortest note durations in the MIDI note data.

12. The singing detection method according to claim 1, wherein, performing the rhythm judgment and the pitch variation judgment to the MIDI note data, respectively assigning weights to the scores for each, and comparing the final total score with the threshold score to determine whether the audio signal is singing, further comprises:
performing a chord analysis by comparing the MIDI note data with a chord data in a database to obtain a chord analysis score; and
based on the scores obtained from the rhythm judgment, the pitch variation judgment, and the chord analysis, assigning respective weighted scores, and comparing the final total score with the threshold score to determine whether the audio signal is singing.

13. A singing detection system, comprising:
An analog front-end processing circuit, comprising an input terminal and an output terminal, wherein the input terminal of the analog front-end processing circuit receives an audio signal and performs a packet-trigger judgment to determine whether to activate a singing detection function;
a tempo detection circuit block, coupled to the analog front-end processing circuit, for receiving a sampled audio signal, and performing a tempo detection, and outputting a tempo detection data when the singing detection function is activated;
a pitch detection circuit block, coupled to the analog front-end processing circuit, when the singing detection function is activated, receiving a sampled audio signal, performing a pitch detection, and obtaining a pitch detection data;
a quantization calculation circuit block, receiving the pitch detection data, performing a quantization operation, and obtaining quantized data;
a data conversion circuit block, receiving the quantized data and the tempo detection data, converting the quantized data and the tempo detection data into Musical Instrument Digital Interface (MIDI) note data; and
a judgment circuit, receiving the MIDI note data, performing a rhythm judgment and a pitch variation judgment, respectively assigning weighted to scores for each, and comparing a final total score with a threshold score to determine whether the audio signal is singing.

14. The singing detection system according to claim 13, wherein the tempo detection circuit block further performs an onset detection, the onset detection comprising:
searching for local peak values on the received sampled audio signal along its timeline; and
selecting onset events based on the time and intensity of the local peak values to obtain the tempo detection data.

15. The singing detection system according to claim 13, wherein the operation of the pitch detection circuit block further comprises:
splitting the received sampled audio signal into a plurality of audio frames;
performing an autocorrelation calculation on the plurality of audio frames with different delay times, obtaining multiple autocorrelation functions, multiple peaks, and corresponding peak delay times;
using the peak delay times of the multiple peaks as the fundamental period; and
calculating the fundamental frequency of the audio frame based on the fundamental period.

16. The singing detection system according to claim 15, wherein the plurality of audio frames are represented as s (t), and the autocorrelation function calculation comprises:
r(τ)=Σs(t)s(t+τ)
where r(τ) represents the autocorrelation function;
where τ represents the delay time;
where, by varying the delay time τ, the peak values of the autocorrelation function r(τ) are identified; and
where the adjacent peak values are used as the fundamental period T to obtain the fundamental frequency f=1/T of the calculated audio frame s(t).

17. The singing detection system according to claim 13, wherein the analog front-end processing circuit further comprises:
a sampling circuit, for sampling the audio signal to obtain the sampled audio signal;
a low-pass filter, for applying a low-pass filtering to the sampled audio signal to obtain a low-pass filtered audio signal;
a framewise energy conversion circuit, receiving the low-pass filtered audio signal and performing a framewise energy conversion; and
a Voice Activity Detection (VAD) circuit, coupled to the framewise energy conversion circuit, performing binary output based on the framewise energy conversion result to determine whether to activate the singing detection function.

18. The singing detection system according to claim 13, wherein the judgment circuit performs the rhythm judgment using the MIDI note data, comprises:
performing a rhythm validity judgment to obtain a rhythm validity score; and
performing a rhythm continuity judgment, where the rhythm continuity of the MIDI note data is evaluated to obtain a rhythm continuity score.

19. The singing detection system according to claim 18, wherein performing the rhythm validity judgment to obtain the rhythm validity score comprises:
calculating a beats per minute (BPM) for the MIDI note data;
setting the rhythm validity score to a first score when the BPM is below a low beat threshold or above a high beat threshold; and
setting the rhythm validity score to a second score when the BPM is above the low beat threshold and below the high beat threshold.

20. The singing detection system according to claim 18, wherein, performing the rhythm continuity judgment, the rhythm continuity of the MIDI note data is evaluated to obtain the rhythm continuity score, comprising:
performing an autocorrelation operation on the MIDI note data; and
using a result of the autocorrelation operation as the rhythm continuity score.

21. The singing detection system according to claim 13, wherein the judgement circuit performing the pitch variation judgment by MIDI note data comprises:
performing a pitch variation judgment by comparing the MIDI note data to detect scale variations, and obtaining a pitch variation score; and
performing a sustain judgment by evaluating the sustain duration of the MIDI note data, and obtaining a sustain score.

22. The singing detection system according to claim 21, wherein, performing the pitch variation judgment by comparing the MIDI note data to detect scale variations, and obtaining the pitch variation score, comprising:
identifying a highest and lowest notes in the MIDI note data;
calculating the pitch variation score based on the difference between the highest and lowest notes in the MIDI note data.

23. The singing detection system according to claim 21, wherein, performing the sustain judgment by evaluating the sustain duration of the MIDI note data, and obtaining the sustain score, comprising:
identifying the longest and shortest note durations in the MIDI note data;
calculating the sustain score based on the longest and shortest note durations in the MIDI note data.

24. The singing detection system according to claim 13, wherein, the judgement circuit performing the rhythm judgment and the pitch variation judgment to the MIDI note data, respectively assigning weights to the scores for each, and comparing the final total score with the threshold score to determine whether the audio signal is singing, further comprises:
performing a chord analysis by comparing the MIDI note data with a chord data in a database to obtain a chord analysis score; and
based on the scores obtained from the rhythm judgment, the pitch variation judgment, and the chord analysis, assigning respective weighted scores, and comparing the final total score with the threshold score to determine whether the audio signal is singing.
